(19) United States
(12) Patent Application Publication
(10) Pub. No.: US 2024/0400792 A1
(43) Pub. Date: Dec. 5, 2024

(54) CURABLE (METH)ACRYLATE COMPOSITIONS

(71) Applicant: Henkel AG & Co. KGaA, Duesseldorf (DE)

(72) Inventors: Nigel Sweeney, Dublin (IE); James Anthony Houlihan, Dublin (IE); Mark Loane, Dublin (IE)

(21) Appl. No.: 18/738,466

(22) Filed: Jun. 10, 2024

Related U.S. Application Data
(63) Continuation of application No. PCT/EP2022/084648, filed on Dec. 6, 2022.

(30) Foreign Application Priority Data
Dec. 9, 2021 (GB) 2117808.2

(51) Int. Cl. C08K 5/101; C08K 5/14; C08K 5/17; C08K 5/56; C08L 53/02; C09J 133/12

(52) U.S. Cl. CPC C08K 5/101; C08K 5/14; C08K 5/175; C08K 5/56; C08L 53/02; C09J 133/12

(57) ABSTRACT

A two-part curable composition comprising a Part A and a Part B:
Part A comprising:
   (i) a curable (meth)acrylate component;
   (ii) a free radical initiator; and
   (iii) a cyclic β-keto ester wherein the cyclic part of the cyclic β-keto ester comprises an at least 6-membered ring; and
Part B comprising:
   (i) a curable (meth)acrylate component; and
   (ii) a transition metal component.

The compositions of the invention show tack free cure in the presence of oxygen.

### FIELD

The present invention relates to compositions, in particular curable (meth)acrylate composition. Of interest are those which cure to provide a tack-free form. Compositions that can cure despite an oxygen inhibition effect are described. Such compositions are useful in applications where there is a relatively high oxygen inhibition effect. Two-part (also referred to using the shorthand “2K”) compositions are of interest.

### BACKGROUND

Air, in particular oxygen has an inhibiting effect on the cure of curable (meth)acrylate compositions. This is a well-known property and indeed anaerobically curable compositions are provided based on (meth)acrylate compositions.

Incomplete cure of curable (meth)acrylate compositions such as adhesives due to oxygen inhibition can become a problem. For example such a technical problem can arise where the relative surface area of the composition exposed to air is large compared to the amount of the curable composition. For example where a bead of the composition has been applied exposed edges thereof may experience oxygen inhibition. This means that the composition may not fully cure at those exposed edges and will remain tacky or gummy. It will be appreciated that such large surface area exposure can occur where a bead of applied composition is thin (width of a bead) or has a low thickness (height of the bead) or both. In the present invention the width of the applied bead is considered to be the dimension of the bead in a direction that follows the surface of a substrate to be bonded. The thickness/height/depth of the bead is considered to be the dimension of the bead that represents the distance the bead extends above the surface of a substrate to be bonded.

Incomplete cure may be an issue where, for example, where there is a bead with relatively low thickness of the curable composition applied between substrates. The composition may bond the substrates together but the composition exposed at edges of the substrates may not fully cure due to oxygen inhibition.

Such an issue can arise for example where there are beads having low thickness for example <1.0 mm in thickness.

In US Patent Publication No. 2010/297457, to Sika, “(Meth)acrylate composition featuring reduced oxygen inhibition”, 2K methacrylate compositions containing in one part a metal salt and a dicarbonyl compound and in the other a peroxide are described. These compositions give improved drying time to reach a tack-free cure but are limited in stability due to reactions between the peroxide and the dicarbonyl compound.

U.S. Pat. No. 4,442,138, to Westinghouse Electric Corp. “Substrate Pre-treatment with a Meta-Beta Keto ester complex in the method of curing an anaerobic resin”, discloses pre-treating of substrates with a metal-keto-ester can be used to cure anaerobic resin. However, this requires an oxygen-free environment to initiate a tack-free cure.

In European patent no. EP53740, to Bayer, “Air-curable polyacrylate coating” the use of beta-mono-olefinically unsaturated C3-C5-carboxylic acid is disclosed, but the stability of these dicarbonyl compounds in the presence of peroxides is limited.

In European patent no. EP3161084, 3M, “Adhesive precursor composition, two-part adhesive kit, and method of making an adhesive composition” stable compositions of methacrylates containing dicarbonyl and 2-nitrobenzoic acid are disclosed.

Garra et al, Macromolecules 2018, 51, pp 6395-6404 describes the use of metal acetylacetonates and acetylbutyrolactone to free radically cure methacrylates. They also show this has improved surface and depth of cure in comparison to tertiary amine/benzoyl peroxide based free radical curing. However, the most effective combination of manganese tris-acetylacetonate and acetylbutyrolactone has very limited shelf life stability.

International (PCT) Publication No. WO 2019/038040 describes the use of cobalt salts and allyl functionalised polyester diols as means to overcome oxygen inhibition of cure in two-component acrylic systems.

Notwithstanding the foregoing alternative solutions to the issues describe above are desirable.

### SUMMARY OF THE INVENTION

For the above reasons it is desirable to provide a curable (adhesive) composition that addresses a market need for tack free surface, cure at exposed edges and desirable bond strengths on active and passive substrates. As above, it is desirable to provide a composition that cures to provide a tack-free form. It is desirable to provide a composition that can cure despite oxygen inhibition. It is desirable to achieve bonding both on active surfaces and on inactive surfaces. It is further desirable to achieve good bond strengths. Furthermore it is desirable to provide a composition that is non-volatile. It will be appreciated that any composition that achieves all of, or some sub-combination, of such desirable properties will be useful.

End-use applications for (meth)acrylate for example structural (meth)acrylate compositions such as adhesives may use beads of the composition where the beads have a width of less than 1 mm.

In such applications the surface area of the bead is large relative to the inner core of the bead. As a result the thickness/height/depth of the bead is more susceptible to oxygen ingress as the bead is narrower in width. Therefore, having a (meth)acrylate composition with reduced oxygen inhibition of the cure will enhance performance at these narrow bead widths.

In one aspect, the present invention provides a two-part curable composition comprising a Part A and a Part B:
Part A comprising:
   (i) a curable (meth)acrylate component;
   (ii) a free radical initiator; and
   (iii) a cyclic β-keto ester wherein the cyclic part of the cyclic β-keto ester comprises an at least 6-membered ring; and
Part B comprising:
   (i) a curable (meth)acrylate component; and
   (ii) a transition metal component.

Compositions of the invention have been shown to demonstrate good cure properties and are not inhibited to any substantial extent by oxygen (air). In particular tack free cure is achieved even where the composition is exposed to air. The compositions show improved cure in exposed bond areas in combination with excellent metal and composite adhesion in combination with high impact resistance. In respect of the present invention tack free means dry/non-tacky to the touch.

Compositions of the present invention show reduced oxygen inhibition of cure and this is particularly useful as these compositions will cure in end-use applications where there is a relatively large amount of the composition exposed to air and thus oxygen inhibition.

Compositions of the invention show good adhesion as measured by bond strength and this may be achieved at low thickness beads for example at bead thickness of less than 1 mm.

Compositions of the invention show good stability so that they can be stored before use without loss in final performance when cured.

Compositions of the invention show good structural performance.

A cyclic β-keto ester component in a composition of the invention may include cyclic β-keto ester where the cyclic structure is interrupted by one or more heteroatoms such as oxygen.

Additionally or alternatively the ester oxygen atom of a β-keto ester group may be part of a ring of a cyclic structure.

Additionally or alternatively the carbon atom to which the carbonyl oxygen of the ester group is attached, or the carbon atom to which the carbonyl oxygen of the keto group is attached, or both, may be part of a ring of a cyclic structure.

The at least 6-membered ring may be a carbocyclic ring. (It does not contain any heteroatoms).

The cyclic part of the cyclic β-keto ester may be formed by an at least 7-membered ring.

For example the cyclic β-keto ester may be selected from:
(i) ethyl 2-oxocyclohexanecarboxylate;
(ii) methyl 2-oxocyclohexanecarboxylate;
(iii) ethyl 2-oxocycloheptanecarboxylate;
(iv) methyl 2-oxocycloheptanecarboxylate;
(v) ethyl 2-oxocyclooctanecarboxylate;
(vi) methyl 2-oxocyclooctanecarboxylate, and any combination thereof.

Additionally or alternatively the β-keto ester component may comprise: a cyclohexyl, cyclohexenyl, cycloheptyl, cycloheptenyl, cyclooctyl, or cyclooctenyl β-keto ester, a β-keto ester having a fused ring structure such as

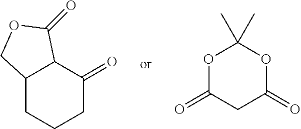

or any combination thereof.

Desirably the cyclic β-keto ester is present in an amount from about 0.5% to about 5% by weight based on the total weight of the composition, for example wherein the cyclic β-keto ester is present in an amount from about 1% to about 3% by weight based on the total weight of the composition.

In a two-part curable composition according to the invention the curable (meth)acrylate component is suitably present in an amount from about 10% to about 90% by weight based on the total weight of the composition, for example wherein the curable (meth)acrylate component is present in an amount from about 30% to about 70% by weight based on the total weight of the composition.

A two-part curable composition according to the invention may further comprise acidic (meth)acrylate monomer. Acidic (meth)acrylate monomer is desirably present in an amount from about 1% to about 30% by weight based on the total weight of the composition, for example wherein the acidic (meth)acrylate monomer is present in an amount from about 5% to about 20% by weight based on the total weight of the composition.

Desirably a two-part curable composition of the invention comprises a toughener. The toughener may be a rubber component. The toughener may be a block copolymer component. The toughener is suitably present in an amount from about 10% to about 60% by weight based on the total weight of the composition, for example from about 20% to about 40% by weight based on the total weight of the composition.

A two-part curable composition of the invention may comprise a core shell rubber. Desirably the core shell rubber is present and is present in an amount up to about 25% by weight based on the total weight of the composition. For example where present the core shell rubber is present in an amount from about 5% to about 20% by weight based on the total weight of the composition.

A two-part curable composition of the invention may comprise a liquid rubber. The liquid rubber is desirably present and when present is present in an amount up to about 20% by weight based on the total weight of the composition. For example when the liquid rubber is present it is desirably present in an amount from about 2.5% to about 15% by weight based on the total weight of the composition.

In a two-part curable composition of the invention the free radical initiator component may be present in an amount from about 0.5% to about 5% by weight based on the total weight of the composition for example the free radical initiator component may be present in an amount from about 1% to about 3% by weight based on the total weight of the composition.

Desirably the free radical initiator component includes a peroxide and/or hydroperoxide. A combination of two or more peroxides and/or two or more hydroperoxides may be employed.

In a two-part curable composition of the invention the transition metal component is desirably vanadium (III) or vanadyl (IV) salt or any combination thereof. The transition metal component is desirably present in an amount from about 0.1% to about 1% by weight based on the total weight of the composition, for example the transition metal component may be present in an amount from about 0.25% to about 0.75% by weight based on the total weight of the composition.

Desirably a two-part curable composition according to the invention comprises a free-radical stabiliser component. Suitably the free-radical stabiliser is present and is present in an amount up to about 1% by weight based on the total weight of the composition, optionally the free-radical stabiliser is present and is present in an amount from about 0.1% to about 0.5% by weight based on the total weight of the composition.

A two-part curable composition of the invention may comprise a chelating agent such as the tetrasodium salt of ethylenediamine tetraacetic acid (“EDTA”). Desirably the chelating agent is present and is present in an amount up to about 1% by weight based on the total weight of the composition, for example wherein the chelating agent is present and is present in an amount from about 0.01% to about 0.1% by weight based on the total weight of the composition.

A two-part curable composition according to any of the preceding claims may be formulated so that the Part A and Part B are present in an about 1:1 weight ratio.

The present invention also relates to a cured product of a two-part curable composition of the invention.

The present invention also relates to an assembly comprising a first substrate bonded to a second substrate the first substrate bonded to the second substrate by a two-part curable composition according to the invention.

Desirably at least one substrate is a glass substrate, for example a glass that forms part of an electronic device, such as a display screen, for example a touch sensitive display screen.

The invention can be described as comprising a two-component system containing in both parts methacrylate monomers and oligomers, rubber tougheners, fillers, free radical stabilizers and other additives typically used in structural methacrylate adhesives.

In the part A, there is a suitable β-keto ester and a free radical initiator such as a peroxide oxidising agent. In the B part there is a redox active metal catalyst, preferably a vanadium (III) or vanadyl (IV) salt.

This invention shows two component methacrylate compositions which contain a redox active metal catalyst, preferably vanadyl (IV) or vanadium (III) acetylacetonate and in the other part a free radical initiator such as a peroxide and a β-keto ester, in which the ketone contain a cyclic hydrocarbon ring. The ring may contain 4-8 carbons, with 6-7 carbons the most preferable. Where the free radical initiator is a peroxide it is desirably a hydroperoxide.

The (meth)acrylate component may be selected from one or more of a wide variety of materials, such as those represented by H₂C=CGCO₂R¹ where G may be hydrogen or alkyl groups having from 1 to about 4 carbon atoms, and R¹ may be selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, carbonate, amine, amide, sulfur, sulfonate, sulfone and the like. Examples include phenoxy ethyl (meth)acrylate, tetrahydrofurfuryl (meth)acrylate, cyclohexyl (meth)acrylate, isobornyl (meth)acrylate, butyl (meth)acrylate, hydroxyethyl (meth)acrylate, and hydroxypropyl (meth)acrylate.

Additional (meth)acrylates suitable for use herein include polyfunctional (meth)acrylates, such as, but not limited to, di- or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri (meth)acrylate (“TMPTMA”), diethylene glycol dimethacrylate, triethylene glycol dimethacrylate (“TRIEGMA”), tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth)acrylate.

Still other (meth)acrylates that may be used herein include silicone (meth)acrylates (“SiMA”), such as those taught by and claimed in U.S. Pat. No. 5,605,999 (Chu), the disclosure of which is hereby expressly incorporated herein by reference.

Of course, combinations of these (meth)acrylates may also be used. Though desirably, the (meth)acrylate component is selected from one or more of N, N-dimethyl acrylamide, phenoxy ethyl (meth)acrylate, tetrahydrofurfuryl (meth)acrylate, cyclohexyl (meth)acrylate, isobornyl (meth)acrylate, butyl (meth)acrylate, hydroxyethyl (meth)acrylate, and hydroxypropyl (meth)acrylate.

Initiators of free radical polymerization may be incorporated into the curable compositions of the invention including hydroperoxides, such as cumene hydroperoxides (“CHP”), para-menthane hydroperoxide, t-butyl hydroperoxide (“TBH”) and t-butyl perbenzoate. Other initiators of free radical polymerization include peroxides, such as benzoyl peroxide, dibenzoyl peroxide, 1,3-bis(t-butylperoxyisopropyl)benzene, 1,1,3,3-tetramethylbutyl hydroperoxide; diacetyl peroxide, butyl 4,4-bis(t-butylperoxy) valerate, p-chlorobenzoyl peroxide, cumene hydroperoxide, t-butyl cumyl peroxide, t-butyl perbenzoate, di-t-butyl peroxide, dicumyl peroxide, 2,5-dimethyl-2,5-di-t-butylperoxyhexane, 2,5-dimethyl-2,5-di-t-butyl-peroxyhex-3-yne, 4-methyl-2,2-di-t-butylperoxypentane and combinations thereof.

The component of the composition of the invention that is a cyclic β-keto ester (wherein the cyclic part of the cyclic β-keto ester comprises an at least 6-membered ring) is distinct from the free radical initiator component of the composition of the invention. The two components are distinct and those two distinct components are each independent of each other. Both are present. So there are two distinct components and both are present in Part A of the composition.

Tougheners include vinyl-terminated polybutadiene, rubbers like ABS rubbers, SBS rubbers, NBR rubbers, and SIS rubbers, and particulate rubber powders, such as core shell rubbers like MBS core shell rubbers, and non-core shell rubbers. For instance, BLENDEX 338 is an ABS powder from GE Plastics.

The vinyl-terminated polybutadienes are desirably in liquid form at room temperature. The vinyl-terminated polybutadienes desirably have a glass transition temperature below 0° C. The vinyl-termination may be in the form of (meth)acrylate-termination, for instance (meth)acrylate-terminated polybutadiene-acrylonitrile copolymers such as HYCAR VTBN, or (meth)acrylate-terminated polybutadiene, such as HYCAR VTB, Emerald Performance Polymers.

A composition of the invention may additionally comprise conventional additives such as thickeners, fillers, pigments, stabilisers, etc., subject to said additives not interfering with effective curing of the adhesive compositions of the invention.

Fillers can provide bulk without sacrificing significant strength of the adhesive and can be selected from high or low density fillers. Also, certain fillers, such as silica, can confer rheological modification or small particle reinforcements. Commercially available examples include CAB-O-SIL 610 and AEROSIL R8200.

Of interest are low density fillers, because the resulting final product has an otherwise lower density than a product without the filler, yet has essentially the same range of strength characteristics as if the filler was not present. An example is glass spacer beads, which may or may not be hollow.

It will be appreciated that compositions of the invention can include non-reactive species including resins. Such components do not participate in an (anaerobic) cure reaction. They are unreactive. Such components may however become part of the cure product having been incorporated therein during the curing of other components. Examples of such non-reactive species include: fumed silica, polyethylene, PTFE, mica, polyamide wax, titanium dioxide, barium sulphate.

### BRIEF DESCRIPTION OF THE DRAWINGS

Embodiments of the invention will be described, by way of example only, with reference to the accompanying drawings in which:

FIG. 1: Test to show improved tolerance of oxygen on cured adhesive samples. Loctite HHD8540 coated glass slide on the top, Example 3 cured composition coated glass slide on the bottom.

### DETAILED DESCRIPTION

The present invention is exemplified with reference to the following Examples.

### COMPARATIVE EXAMPLES AND EXAMPLES OF THE INVENTION

Comparative Example 1 is the commercial product Loctite® HHD8540 available from Henkel Ireland, Dublin Ireland and which is two-part methyl methacrylate (MMA) adhesive

Comparative Example 2—Formulation using dicarbonyl acetylbutyrolactone as per examples in US20100297457A1 (Sika) which was discussed above.

Comparative Example 3—Formulation using dicarbonyl ethyl acetoacetate as per examples in US20100297457A1 (Sika).

Comparative Example 4—Formulation using manganese (III) tris acetylacetonate as per Garra et al, Macromolecules 2018, 51, pp 6395-6404 reference which was discussed above.

Comparative Example 5—Formulation using ethyl 2-oxocyclopentanecarboxylate.

Examples 1-4 are examples of the invention comprising in part A, a suitable β-keto ester according to the invention and a free radical initiator in the form of a peroxide oxidizing agent. In the B part there is a redox active metal catalyst, preferably a vanadium (III) or vanadyl (IV) salt.

Method of sample preparation: Ingredients for the stock solutions were added into a mixing vessel with a lid and mixed in a Speedmixer DAC 150.1 FVZ-K for 10 mins at 2500 rpm. To make the Part A and Part B the ingredients were added to the stock solution and mixed for 2 mins at 2500 rpm. The formulations were then packed into 50 ml 1:1 mix ration 2-component cartridges and filled up to piston height. The cartridges were centrifuged for 2 mins at 1500 rpm to remove bubbles. The pistons were then placed on the cartridges.

TABLE 1
Comparative and example compositions

| Stock Solution-1 | Wt. % |
|---|---|
| MMA | 48 |
| Styrene Butadiene block co-polymer | 22 |
| Core Shell Rubber | 4.4 |
| Vinyl terminated butadiene | 12.8 |
| Paraffinic Wax | 0.4 |
| Methacrylic Acid | 9.9 |
| Bis-HEMA Phosphate | 1.5 |
| Hydrophilic Silica | 1 |

Comparative Example 1
Commercial product Loctite ®
HHD8540

| | | | |
|---|---|---|---|
| Part A | Wt. % | Part B | Wt. % |

Comparative Example 2

| | | | |
|---|---|---|---|
| Stock Solution 1 | 95 | Stock Solution 1 | 99.5 |
| Acetyl butyrolactone | 2.5 | Vanadium (III) | 0.5 |
| Cumene Hydroperoxide | 2.5 | acetylacetonate | |

Comparative Example 3

| | | | |
|---|---|---|---|
| Stock Solution 1 | 95 | Stock Solution 1 | 99.5 |
| Ethyl acetoacetate | 2.5 | Vanadium (III) | 0.5 |
| Cumene Hydroperoxide | 2.5 | acetylacetonate | |

Comparative Example 4

| | | | |
|---|---|---|---|
| Stock Solution 1 | 95 | Stock Solution 1 | 99.5 |
| Acetyl butyrolactone | 2.5 | Manganese (III) tris | 0.5 |
| Cumene Hydroperoxide | 2.5 | acetylacetonate | |

Comparative Example 5

| | | | |
|---|---|---|---|
| Stock Solution 1 | 95 | Stock Solution 1 | 99.5 |
| Ethyl 2- | 2.5 | Vanadium (III) | 0.5 |
| oxocyclopentanecarboxylate | | acetylacetonate | |
| Cumene Hydroperoxide | 2.5 | | |

Example 1

| | | | |
|---|---|---|---|
| Stock Solution 1 | 95 | Stock Solution 1 | 99.5 |
| Ethyl 2- | 2.5 | Vanadium (III) | 0.5 |
| oxocyclohexanecarboxylate | | acetylacetonate | |
| Cumene Hydroperoxide | 2.5 | | |

Example 2

| | | | |
|---|---|---|---|
| Stock Solution 1 | 95 | Stock Solution 1 | 99.5 |
| Ethyl 2- | 2.5 | Vanadium (III) | 0.5 |
| oxocycloheptanecarboxylate | | acetylacetonate | |
| Cumene Hydroperoxide | 2.5 | | |

Example 3

| | | | |
|---|---|---|---|
| Stock Solution 1 | 95 | Stock Solution 1 | 99.5 |
| Ethyl 2- | 2.5 | Vanadium (III) | 0.5 |
| oxocyclooctanecarboxylate | | acetylacetonate | |
| Cumene Hydroperoxide | 2.5 | | |

Example 4

| | | | |
|---|---|---|---|
| Stock Solution 1 | 95 | Stock Solution 1 | 99.7 |
| Ethyl 2- | 2.5 | Vanadyl(IV) | 0.3 |
| oxocyclooctanecarboxylate | | acetylacetonate | |
| Cumene Hydroperoxide | 2.5 | | |

TABLE 2
Stability after 1 h after sample preparation:

| Stability after 1 hour | Part A | Part B |
|---|---|---|
| Comparative Example 1—HHD8540 | NT | NT |
| Comparative Example 2 | Y | Y |
| Comparative Example 3 | Y | N |
| Comparative Example 4 | Y | Y |
| Comparative Example 5 | Y | Y |
| Example 1 | Y | Y |
| Example 2 | Y | Y |
| Example 3 | Y | Y |
| Example 4 | Y | Y |

MMA is methyl methacrylate. Bis HEMA phosphate is an adhesion promoter and is Bis [2-(methacryloyloxy) ethyl] phosphate.

In this test, the samples packed into cartridges were tested for dispense. Y means the part could be dispensed. N means the part could not be dispensed. NT means not tested.

This test shows that part B in comparative Example 3 shows very limited stability when manganese (III) tris acetylacetonate is combined with methacrylate adhesive ingredients required for good adhesive performance, showing the limitation of the cure system shown in the Garra et al, Macromolecules 2018, 51, pp 6395-6404 reference discussed above.

TABLE 3
Stability tests in cartridges stored at 55° C.:

| Stability at 55° C. | Part A | Part B |
|---|---|---|
| Comparative Example 1 HHD8540 | >5 days | NT |
| Comparative Example 2 | <24 h | >5 days |
| Comparative Example 3 | <24 h | >5 days |
| Comparative Example 4 | <24 h | <24 h |
| Comparative Example 5 | 24 h< >48 h | >5 days |
| Example 1 | >15 days | >5 days |
| Example 2 | >15 days | >5 days |
| Example 3 | >15 days | >5 days |
| Example 4 | >15 days | >5 days |

In this test, the samples packed into cartridges were tested for dispense. Y means the part could be dispensed. N means the part could not be dispensed. NT means not tested. This test shows that the cyclic β-keto ester compound must contain an at least 6-membered ring, for example and an at least 6-membered ring which includes the ketone of the keto ester, to enable sufficient stability of the composition.

### Adhesive Performance

Adhesion tests were done according to ASTM D3163-01. The tests were done on 50% glass-filled polyarylamide lap shears primed with Loctite SF 7952. The primer volatiles were allowed to evaporate in a fume hood for 5 minutes after being brushed applied on the substrates. The adhesive in a 50 ml cartridge was dispensed through a static mixer nozzle type. Bonds were made with a 0.25″ (0.635 cm) overlap and initially cured at 45° C. for 20 min, then followed by 24 hours at room temperature.

TABLE 4
0.25″ (0.635 cm) overlap Lap shear Strengths:

| | Lap shear | Mode of |
|---|---|---|
| | strength (MPa) | Adhesive Failure |
| Comparative | 21.2 +/− 1.3 | Cohesive |
| Example 1 | | |
| HHD8540 | | |
| Comparative | 22.4 +/− 0.8 | Cohesive |
| Example 5 | | |
| Example 1 | 21.1 +/− 1.2 | Cohesive |
| Example 2 | 24.1 +/− 2.8 | Cohesive |
| Example 3 | 26.6 +/− 0.3 | Cohesive |
| Example 4 | 23.6 + 1.0 | Cohesive |

This shows that the example compositions give adhesive performance on composite substrates, as is as expected for structural methacrylate adhesives.

### Impact Resistance Tests.

Tests were done according to ISO 11343 “Adhesives—Determination of dynamic resistance to cleavage of high-strength adhesive bonds under impact conditions—Wedge impact method”. The test substrates were symmetric hot dipped galvanised steel DC-04 wedge coupons. The adhesives were applied as in the previous tests at an induced bond gap of 125 μm. Bonded test specimens were cured at 45° C. for 20 minutes followed by 24 hours at room temperature.

Tests were done on a CEAST 9350 drop impact tower at an impact velocity of 2 m/s.

TABLE 5
Dynamic resistance to cleavage (NT means not tested).

| | | Mode of |
|---|---|---|
| | kN/m | Adhesive Failure |
| Comparative Example 1 HHD8540 | 15.2 +/− 1.3 | Cohesive |
| Comparative Example 5 | 19.4 +/− 2.0 | Cohesive |
| Example 1 | NT | NT |
| Example 2 | 30.6 +/− 1.5 | Cohesive |
| Example 3 | 28.8 +/− 0.8 | Cohesive |
| Example 4 | 30.0 +/− 3.1 | Cohesive |

This shows that examples made with the new technology can give excellent impact resistance that is expected for structural methacrylate adhesives.

### Test to Show Improved Tolerance of Oxygen on Cured Adhesive Samples.

The test was done as follows: The adhesives were dispensed from a 50 ml 1:1 mix ratio 2-component cartridge through a Sulzer MBH-04-16S mixing nozzle onto a glass slide. The coating thickness was controlled to a thickness/depth of 75 μm. The coated glass slides were then placed in an oven for 20 minutes at 45° C. and removed and allowed to cure for a further 24 h at room temperature.

A grit retention test was then done on the coated slides. Silicon carbide F80 grit was applied to completely cover the adhesive surface. The grit was then brushed off using a 1 inch (2.54 cm) wide soft fine-haired paint brush.

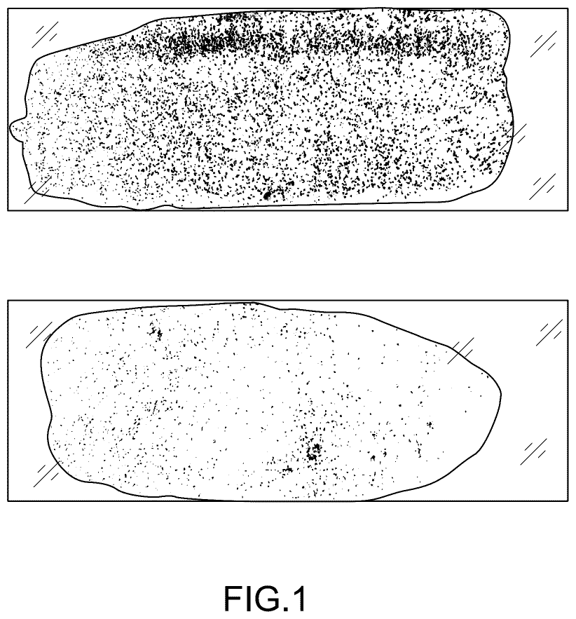

FIG. 1 shows the retention of grit on the coated surfaces after brushing the grit off. Retention of grit is due to tackiness of the adhesive surface. The coated slide shown on top is coated with the 2-component MMA Loctite HHD8540. The coated slide on the bottom is coated with the compositions in Example 1. It is clear from FIG. 1 that the cured Example 1 composition shows far less retention of grit and therefore less surface tackiness. This indicates greater tolerance of the oxygen inhibition of the cure.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

What is claimed is:

1. A two-part curable composition comprising a Part A and a Part B:
Part A comprising:
(i) a curable (meth)acrylate component;
(ii) a free radical initiator; and
(iii) a cyclic β-keto ester wherein the cyclic part of the cyclic β-keto ester comprises an at least 6-membered ring; and
Part B comprising:
(i) a curable (meth)acrylate component; and
(ii) a transition metal component.

2. A two-part curable composition according to claim 1 wherein the at least 6-membered ring is a carbocyclic ring (and does not contain any heteroatoms).

3. A two-part curable composition according to claim 1 wherein the cyclic part of the cyclic β-keto ester is formed by an at least 7-membered ring.

4. A two-part curable composition according to claim 1 wherein the cyclic β-keto ester is selected from:
ethyl 2-oxocyclohexanecarboxylate;
methyl 2-oxocyclohexanecarboxylate;
ethyl 2-oxocycloheptanecarboxylate;
methyl 2-oxocycloheptanecarboxylate;
ethyl 2-oxocyclooctanecarboxylate;
methyl 2-oxocyclooctanecarboxylate, and any combination thereof.

5. A two-part curable composition according to claim 1 wherein the cyclic β-keto ester is present in an amount from about 0.5% to about 5% by weight based on the total weight of the composition.

6. A two-part curable composition according to claim 1 wherein the cyclic β-keto ester is present in an amount from about 1% to about 3% by weight based on the total weight of the composition.

7. A two-part curable composition according to claim 1 wherein the curable (meth)acrylate component is present in an amount from about 10% to about 90% by weight based on the total weight of the composition.

8. A two-part curable composition according to claim 1 wherein the curable (meth)acrylate component is present in an amount from about 30% to about 70% by weight based on the total weight of the composition.

9. A two-part curable composition according to claim 1 wherein the composition comprises acidic (meth)acrylate monomer.

10. A two-part curable composition according to claim 9 wherein acidic (meth)acrylate monomer is present in an amount from about 1% to about 30% by weight based on the total weight of the composition.

11. A two-part curable composition according to claim 9 wherein the acidic (meth)acrylate monomer is present in an amount from about 5% to about 20% by weight based on the total weight of the composition.

12. A two-part curable composition according to claim 1 wherein the composition comprises a toughener.

13. A two-part curable composition according to claim 12 wherein the toughener is a rubber component.

14. A two-part curable composition according to claim 12 wherein the toughener is a block copolymer component.

15. A two-part curable composition according to claim 12 wherein the toughener is present in an amount from about 10% to about 60% by weight based on the total weight of the composition.

16. A two-part curable composition according to claim 12 wherein the toughener is present in an amount from about 20% to about 40% by weight based on the total weight of the composition.

17. A two-part curable composition according to claim 1 wherein the composition comprises a core shell rubber.

18. A two-part curable composition according to claim 17 wherein the core shell rubber is present and is present in an amount up to about 25% by weight based on the total weight of the composition.

19. A two-part curable composition according to claim 17 wherein the core shell rubber is present and is present in an amount from about 5% to about 20% by weight based on the total weight of the composition.

20. A two-part curable composition according to claim 1 wherein the composition comprises a liquid rubber.

21. A two-part curable composition according to claim 20 wherein the liquid rubber is present and is present in an amount up to about 20% by weight based on the total weight of the composition.

22. A two-part curable composition according to claim 20 wherein the liquid rubber is present and is present in an amount from about 2.5% to about 15% by weight based on the total weight of the composition.

23. A two-part curable composition according to claim 1 wherein the free radical initiator component is present in an amount from about 0.5% to about 5% by weight based on the total weight of the composition.

24. A two-part curable composition according to claim 1 wherein the free radical initiator component is present in an amount from about 1% to about 3% by weight based on the total weight of the composition.

25. A two-part curable composition according to claim 1 wherein the transition metal component comprises vanadium (III) salt or vanadyl (IV) salt or any combination thereof.

26. A two-part curable composition according to claim 1 wherein the transition metal component is present in an amount from about 0.1% to about 1% by weight based on the total weight of the composition.

27. A two-part curable composition according to claim 1 wherein the transition metal component is present in an amount from about 0.25% to about 0.75% by weight based on the total weight of the composition.

28. A two-part curable composition according to claim 1 wherein the composition comprises a free-radical stabiliser component.

29. A two-part curable composition according to claim 28 wherein the free-radical stabiliser is present and is present in an amount up to about 1% by weight based on the total weight of the composition.

30. A two-part curable composition according to claim 28 wherein the free-radical stabiliser is present and is present in an amount from about 0.1% to about 0.5% by weight based on the total weight of the composition.

31. A two-part curable composition according to claim 1 wherein the composition comprises a chelating agent such as the tetrasodium salt of ethylenediamine tetraacetic acid (“EDTA”).

32. A two-part curable composition according to claim 31 wherein the chelating agent is present in an amount up to about 1% by weight based on the total weight of the composition.

33. A two-part curable composition according to claim 31 wherein the chelating agent is present in an amount from about 0.01% to about 0.1% by weight based on the total weight of the composition.

34. A two-part curable composition according to claim 1 wherein the Part A and Part B are present in an about 1:1 weight ratio.

35. The cured product of a two-part curable composition according to claim 1.

36. An assembly comprising a first substrate bonded to a second substrate the first substrate bonded to the second substrate by a two-part curable composition according to claim 1.

37. An assembly according to claim 36 wherein at least one substrate is a glass substrate.
